(19) United States
(12) Patent Application Publication
(10) Pub. No.: US 2008/0214347 A1
(43) Pub. Date: Sep. 4, 2008

(54) Drive Unit Comprising Nested Electric Motors

(76) Inventors: Stephan Scharfenberg, Tuttleben (DE); Karl-Hermann Ketteler, Markdorf (DE); Kai Heinrich, Waldburg (DE)

Correspondence Address: DAVIS BUJOLD & Daniels, P.L.L.C., 112 PLEASANT STREET, CONCORD, NH, 03301, US

(21) Appl. No.: 12/067,089

(22) PCT Filed: Sep. 20, 2006
(86) PCT No.: PCT/EP2006/009127

§ 371 Date: Mar. 17, 2008

(30) Foreign Application Priority Data
Sep. 29, 2005 (DE) 10 2005 046 617.6

(51) Int. Cl. F16H 37/06

(52) U.S. Cl. 475/5

(57) ABSTRACT

A drive unit (1) with a steering motor and a propulsion motor, a first (2) of the two motors having a hollow drive shaft (5) through which a drive shaft (14) of a second motor (10) passes. Winding heads (7) of the first motor are positioned radially inside winding heads (15) of the second motor and overlap with them in axial direction, to save structural space in the axial direction. A stator (11) of the second motor is not solid but hollow with a port or bell shape. A rotor (12) of the second motor is in contact with the associated drive shaft not over its entire axial length, but only at a first end (13) which forms the bottom of the pot. This design forms a hollow space in which elements of the first motor can be accommodated at least partially. Parts of the two electric motors (2, 10) overlap in axial direction, where further axial structural space is advantageously saved.

The invention relates to an electric drive unit with a steering motor and a propulsion motor according to the preamble of claim 1.

Conveyor trolleys have known drive units in which a wheel of the vehicle is driven by a propulsion motor and steered by a steering motor.

Accordingly DE 199 49 351 A1 discloses an electric drive unit for a conveyor trolley in which a drive motor and a steering motor are arranged co-axially and the two electric motors are mounted vertically in the vehicle. A reduction transmission is located between the propulsion drive and the steering drive.

DE 103 28 651 A1 shows an electric drive unit in which, likewise, a drive motor and a steering motor are arranged co-axially and mounted vertically in the vehicle. The propulsion motor is directly above the steering motor.

The purpose of the present invention is to provide a drive unit with co-axially arranged propulsion and steering motors that can steer and drive a vehicle wheel and are designed in a particularly space-saving way in the axial direction.

This objective is achieved with a drive unit having the characterizing features of claim 1.

According to the invention, the objective is achieved by an electric drive unit with a steering motor and a propulsion motor arranged co-axially with one another.

A first one of the two motors has a hollow drive shaft through which the drive shaft of the second motor passes. The steering motor drives a wheel of the vehicle in the sense of a steering movement and the propulsion motor drives the vehicle wheel in the sense of a propulsive drive movement. Each of the two electric motors consist of a stator and a rotor. The stators have coils whose windings project out of the stators in the axial direction at least at one of their ends. These winding ends are usually called winding heads. The outer diameter of the winding heads of the first motor is smaller than the inner diameter of the winding heads of the second motor. The two motors are arranged so that the winding heads of the two motors overlap in the axial and radial directions.

In an advantageous embodiment, the rotor of the second motor is not solid, but hollow. The rotor has the shape of a bell or pot closed at one end and open at a second end. Thus, the rotor is in contact with the associated drive shaft not over its entire axial length, but only at its first end. This rotor shape forms a hollow space in which elements of the first motor are arranged at least in part. Consequently, parts of the two electric motors overlap in the axial direction, where axial structural space is saved.

According to another embodiment, a bearing of the drive axis of the first motor projects into the rotor of the second motor.

In a further embodiment, the outer diameter of the stator of the first motor is smaller than the inner diameter of the rotor of the second motor. Part of the first motor extends into the hollow rotor of the second motor. The wall thickness of the hollow rotor of the second motor is determined by the design of the magnetic circuit and the thickness of the end of the hollow rotor by the torque to be transmitted.

In a further embodiment, alternating-current motors in the form of synchronous (also BDLC) or asynchronous motors are used for the two electric motors.

According to another embodiment, the first motor is the steering motor and the second motor is the propulsion motor of the electric drive unit.

Below, the invention is explained in more detail with reference to the attached drawings, which show:

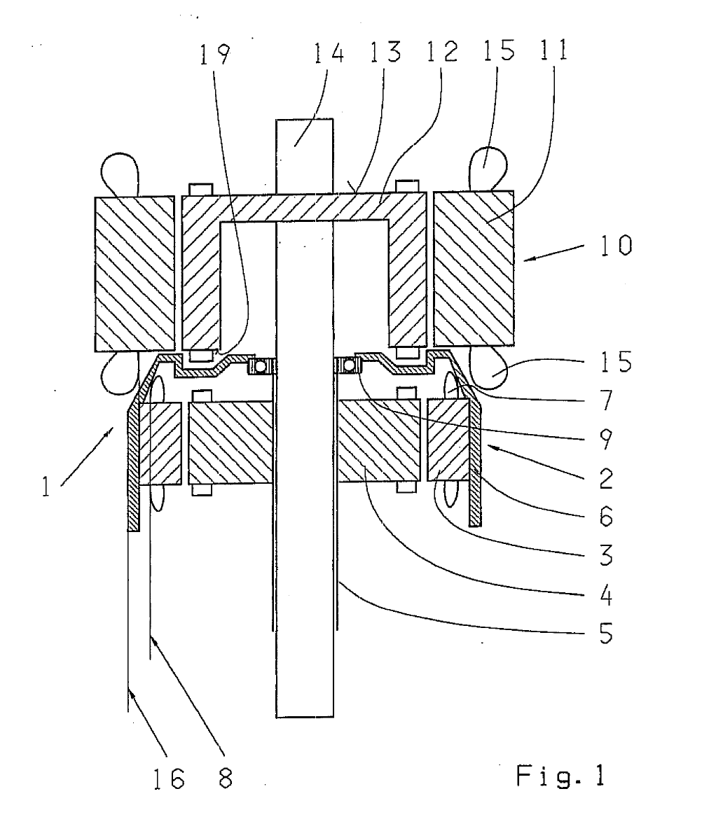

FIG. 1 is a structure of a first drive unit, and

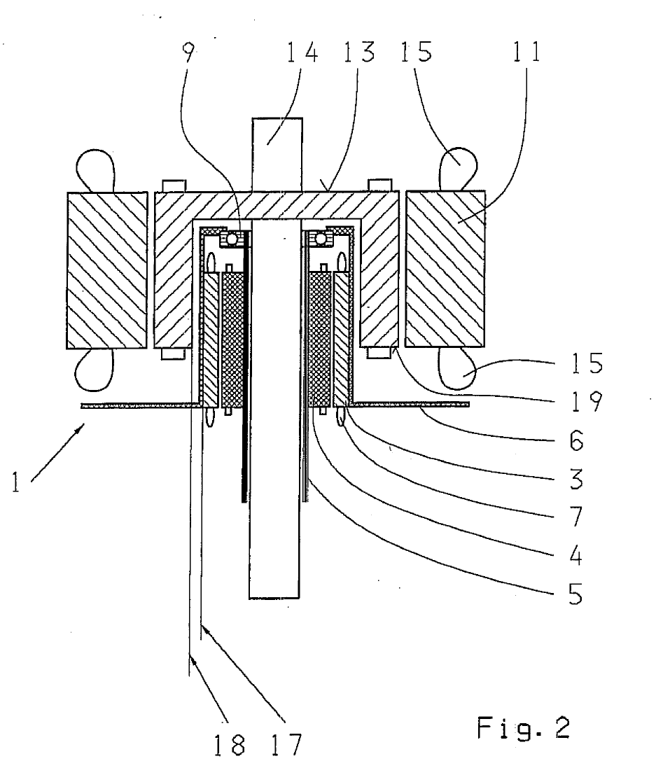

FIG. 2 is a structure of a second drive unit.

FIG. 1 shows a drive unit 1 with a first motor 2, which comprises at least a first stator 3 and a first rotor 4 and which serves as a steering motor. The vehicle wheel is steered by way of hollow drive shaft 5 of the steering motor 2. The rotor 4 of the steering motor 2 is in rotationally fixed connection with the drive shaft 5 and the stator 3 with a motor housing 6. The windings of the stator 3 form winding heads 7 at their axial ends with an outer diameter 8. A bearing 9 supports the hollow drive shaft 5 in the motor housing 6.

A second motor 10 is arranged axially above the first motor 2 also comprises a stator 11 and a rotor 12 and serves as the propulsion drive motor.

The rotor 12 is hollow and has the shape of a pot closed at one end 13 and open at a second end 19. The first end 13 of the rotor 12 is connected rotationally fixed to a drive shaft 14, which extends through the hollow drive shaft 5 of the steering motor 2 and drives the vehicle wheel so that the vehicle can move forward. The windings of the stator 11 form winding heads 15, which project out of the stator 11 in the axial direction. These winding heads 15 have an inner diameter 16 which is larger than the outer diameter of the winding heads 7 of the steering motor 2. Moreover, the steering motor 2 is arranged so that in the axial direction its winding heads 7 overlap with the winding heads 15 of the propulsion motor 10, to save structural space in the axial direction. In addition, the bearing 9 of the steering motor 2 projects into the hollow rotor 12 of the propulsion motor 10.

FIG. 2 shows the first motor 2 with the stator 3 and the rotor 4, which serves as the steering motor. The drive shaft 5 of the steering motor 2 is hollow and steers the vehicle wheel. The rotor 4 of the steering motor 2 is connected in a rotationally fixed manner to the drive shaft 5 and the stator 3 to the motor housing 6. The bearing 9 supports the hollow drive shaft 5 in the motor housing 6. The stator 3 has an outer diameter 17. The second motor 10 is arranged axially above the first motor 2, also has the stator 11 and the rotor 12 and serves as the propulsion motor. The rotor 12 has the shape of a bell or pot, which is closed at the first end 13 and open at the second end 19. The first end 13 of the rotor 12 is connected rotationally fixed to the drive shaft 14, which passes through the hollow drive shaft 5 of the steering motor and drives the vehicle wheel so that the vehicle can move forward. The propulsion motor 10 has an inner diameter 18 which is larger than the outer diameter of the stator 3 of the steering motor 2. In an advantageous design most of the steering motor 2, together with its housing 6, project into the hollow rotor 12 of the propulsion motor 10.

### REFERENCE NUMERALS

1 electric drive unit
2 first motor
3 stator
4 rotor
5 drive shaft
6 housing
7 winding head
8 outer diameter
9 bearing
10 second motor
11 stator
12 rotor
13 rotor end
14 drive shaft
15 winding head
16 inner diameter
17 outer diameter
18 inner diameter
19 rotor end

1-6. (canceled)

7. An electric drive unit with a steering motor and a propulsion motor, which consist at least of a rotor and a stator arranged co-axially with one another, and which respectively steer a wheel of a vehicle or drive the wheel in a sense of a propulsion movement, a first motor (2) having a hollow drive shaft (5) through which a drive shaft (14) of the second motor (10) passes,
wherein winding heads (7) of a stator (3) of the first motor (2) are radially inside winding heads (15) of a stator (11) of the second motor (10) and the winding heads (7, 15) of the first motor (2) and the second motor (10) axially overlap one another.

8. The drive unit according to claim 7, wherein the rotor (12) of the second motor (10) is hollow and has a shape of a pot, a first end (13) of the rotor (12) of the second motor (10) is connected, in a rotationally fixed manner, to the drive shaft (14) of the second motor (10) and a second end (19) of the rotor (12) of the second motor (10) is open, and the rotor (12) of the second motor (10) at least partially encloses elements of the first motor (2).

9. The drive unit according to claim 7, wherein a bearing (9) of the drive shaft (5) of the first motor (2) axially overlaps the winding heads (15) of the second motor (10).

10. The drive unit according to claim 9, wherein an outer diameter (17) of the stator (3) of the first motor (2) is smaller than an inner diameter (18) of the rotor (12) of the second motor (10) and the first motor (2) is positioned at least partially radially inside the rotor (12) of the second motor (10) and axially projects into the rotor (12) of the second motor (10).

11. The drive unit according to claim 7, wherein the two motors (2, 10) are one of synchronous or asynchronous alternating-current motors.

12. The drive unit according to claim 7, wherein the first motor (2) is the steering motor and the second motor (10) is the propulsion motor of the drive unit.

13. An electric drive unit comprising:
a first motor (2) having a rotor (4) and a stator (3) with winding heads (7), and the rotor (4) being rotationally fixed to a hollow drive shaft (5) which rotates about a rotational axis; and
a second motor (10) being coaxially aligned with the first motor (2) and having a rotor (12) and a stator (11) with winding heads (15), and the rotor (12) being cylindrical, closed at a first end (13), open at a second end (19) and rotationally fixed to a second drive shaft (14) at the closed first end (13),
the second drive shaft (14) passing through the hollow first drive shaft (5) and rotating about the rotational axis, the winding heads (15) of the rotor (I 2) of the second motor (10) having an inner diameter larger than an outer diameter of the winding heads (7) of the rotor (4) of the first motor (2), and the winding heads (15) of the rotor (12) of the second motor (10) radially overlapping the winding heads (7) of the rotor (4) of the first motor (2).

14. The electric drive unit according to claim 13, wherein at least a portion of the stator (3) and the rotor (4) of the first motor (2) are located within the rotor (12) of the second motor (10) which passes through the open second end (19) of the rotor (12) of the second motor (10)
